(19) United States
(12) Patent Application Publication
(10) Pub. No.: US 2005/0152627 A1
(43) Pub. Date: Jul. 14, 2005

(54) Bearing assembly with wear-resistant bearing surfaces

(75) Inventors: Chin-Long Ku, Tu-Cheng (TW); Chin-Wen Yeh, Tu-Cheng (TW); Chih-Hao Yang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-cheng City (TW)

(21) Appl. No.: 10/892,074

(22) Filed: Jul. 15, 2004

(30) Foreign Application Priority Data
Jan. 8, 2004 (CN) 200420014784.5

(51) Int. Cl. F16C 33/02

(52) U.S. Cl. 384/276

(57) ABSTRACT

A bearing assembly includes a tube (30) axially defining an inner hole (32), a radial bearing (10) fixed in the inner hole of the tube and having an inner bearing surface concentric with the inner hole, and a shaft (20) pivotably received the inner hole. The shaft comprises a contact portion (22, 220) circumferentially formed at an outer periphery thereof confronting with the inner bearing surface of the bearing. The contact portion comprises an outer bearing surface being configured to have a substantially same abrasive resistance with the bearing surface to reduce wear thereon.

### TECHNICAL FIELD

The present invention relates generally to bearing assemblies, and more particularly, to bearing assemblies having improved wear-resistant ability for use in computer cooling fans or disk drives.

### BACKGROUND

In recent years, magnetic recording devices such as hard disk drives, floppy disk drives, optical recording devices such as CD-ROMs, DVD-ROMs, and computer cooling fans have made a remarkable development. In any one of such electronic equipments, a disk or a flow impeller is mounted to a shaft. A rotational driver such as an electrical motor rotates the shaft with a high speed. The disk or the flow impeller is thus driven to rotate with the shaft for reading/writing data or moving flow.

Also, in any one of such electronic equipments, the shaft is supported by a bearing member. During rotation, the outer surface of the shaft slidingly contacts with a bearing surface of the bearing member. This will inevitably cause wear on the outer surface of the shaft and the bearing surface of the bearing. In particular, when the bearing surface of the bearing member and the outer surface of the shaft have different abrasive resistance they show different wear-resistant abilities. As a result, the surface with lower wear-resistance wears more rapidly than the surface with relatively higher wear-resistance. Once the wear occurs, wear particles are produced between the two surfaces. The wear particles will continuously scratch the two surfaces. The scratch will accelerate the surface wear. As the wear becomes worse, the rotation of the shaft becomes unstable, the rotational precision decreases quickly, disgusting noise will be generated, and the lifespan of the electronic equipments will thus be shortened.

For the foregoing reasons, there is a need for a bearing assembly which has a good wear-resistant ability.

### SUMMARY OF THE INVENTION

The present invention is directed to a bearing assembly which can provide an improved wear-resistant ability.

A bearing assembly having features of the present invention comprises a tube axially defining an inner hole, a radial bearing fixed in the inner hole of the tube and an inner bearing surface concentric with the inner hole, and a shaft pivotably received in the inner hole. The shaft comprises a contact portion circumferentially formed at an outer periphery of the shaft confronting with the inner bearing surface of the bearing. The contact portion comprises an outer bearing surface being configured to have a substantially same abrasive resistance with the bearing surface to reduce wear thereon.

Other objects, advantages and novel features of the present invention will be drawn from the following detailed description of the preferred embodiments of the present invention with attached drawings, in which:

### BRIEF DESCRIPTION OF THE DRAWINGS

FIG. 1 is a cross-sectional view of a bearing assembly embodying features of the present invention;

FIG. 2 is an enlarged, front plan view of a shaft of the bearing assembly of FIG. 1; and

FIG. 3 is a side, plan view of another embodiment of the shaft.

### DESCRIPTION OF PREFERRED EMBODIMENTS

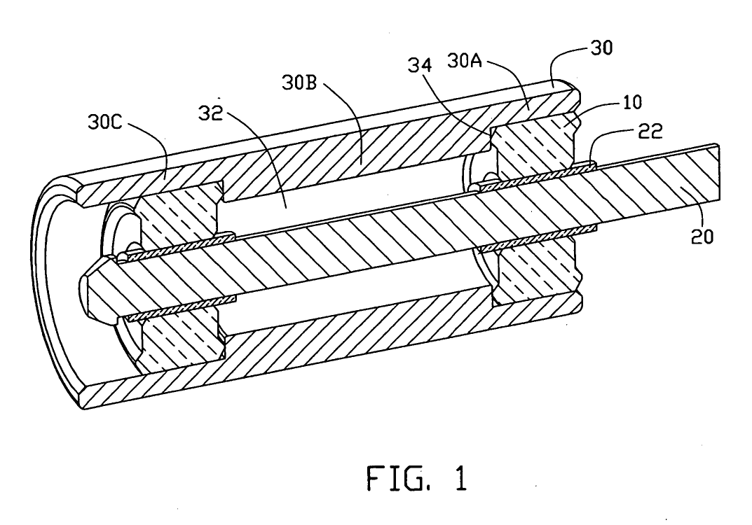

Referring to FIG. 1, a bearing assembly comprises a tube 30, a pair of radial bearings 10 fixed in the tube 30 at opposite ends thereof, and a shaft 20 supported by the radial bearings 10.

The tube 30 has an axial inner hole 32 for receiving the radial bearings 10 therein. The tube 30 comprises opposite end sections 30A, 30C, and a middle section 30B. The diameter of the inner hole 32 at the end sections 30A, 30B of the tube 30 is greater than that at the middle section 30B of the tube 30, so that a pair of annular inner steps 34 is formed between the middle section 30B and the end sections 30A, 30C of the tube 30 respectively.

The radial bearings 10 are sleeve bearings, and are fitted in the end sections 30A, 30C of the tube 30. The radial bearings 10 are engaged with the inner steps 34 to prevent axial movement thereof. Each radial bearing 10 defines an inner bearing surface (not labeled) concentric with the inner hole 32 of the tube 30.

The shaft 20 is pivotably supported on the bearing surfaces of the radial bearings 10. A contact portion 22 is integrally formed at an outer periphery of the shaft 20, corresponding to each bearing 10. The contact portion 22 is in a form of a ring and has a cylindrical outer bearing surface (not labeled), confronting with the inner bearing surface of the corresponding bearing 10.

The outer bearing surface of the contact portion 22 and the inner bearing surface of the bearing 10 are configured to have a substantially same abrasive resistance, so that wear thereon is dramatically reduced during working to ensure an increased lifespan of the bearing assembly. The bearing 10 and the contact portion 22 are made of same material, and preferably are made of material with high abrasive resistance, such as ceramic material. Alternatively, the bearing 10 and the contact portion 22 are made of different materials but having substantially the same abrasive resistance. These different materials with substantially the same abrasive resistance can be prepared by introducing certain hardener, such as Nickel, Zinc, into different alloy materials. It is already known in the field of alloy production that the abrasive resistance of the alloy so prepared varies according to the amount of the hardener being used. Therefore, The same abrasive resistance property can be obtained through controlling the amount of the hardener. Alternatively, only the inner bearing surface area of the bearing 10 and the outer bearing surface area of the contact portion 22 are made of the material having substantially the same abrasive resistance. This can be achieved by surface hardening technology, such as carburizing or nitriding.

In the bearing assembly described above, only the contact portions 22 of the shaft 20 contact with the bearings 10, and the abrasive resistance of the outer bearing surfaces of the contact portions 22 are substantially the same with the inner bearing surfaces of the bearings 10. In other words, the two contact surfaces share the same wear-resistance; therefore, neither of the bearings 10 and the contact portions 22 is subject to severe wear during operation.

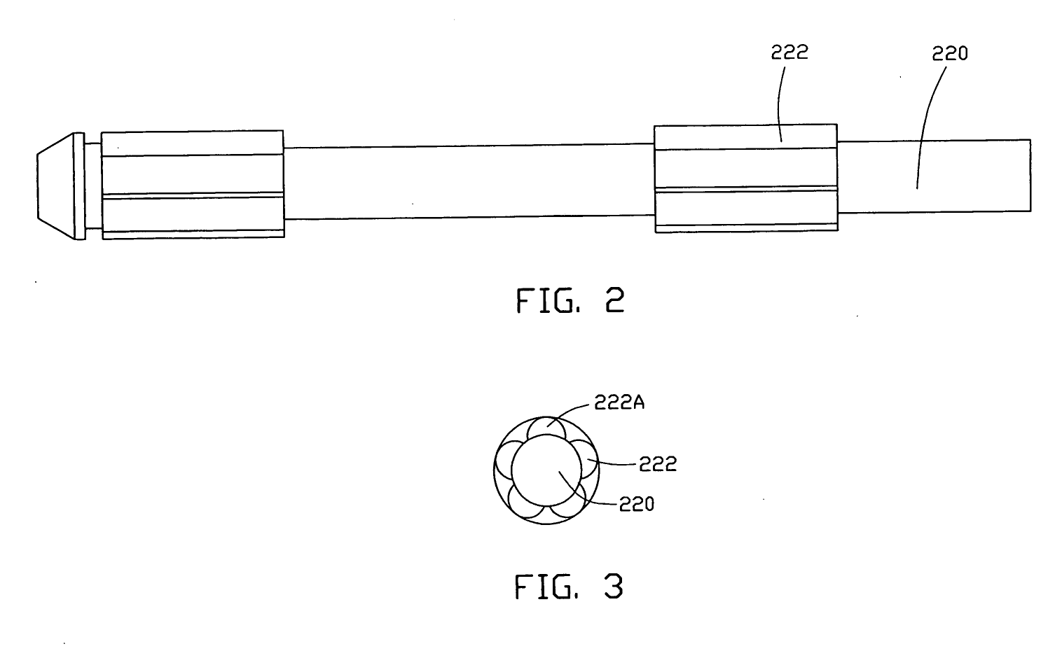

FIG. 2 shows another embodiment of a shaft 220 of a bearing assembly of the present invention. The shaft 220 comprises a pair of spaced contact portions 222 formed at an outer circumferential periphery thereof.

Referring to FIG. 3, in a side plan view, the contact portion 222 comprises a plurality of lobes 222A integrally extending radially from the outer periphery of the shaft 220. Outermost portions of the lobes 222A with respect to the axis of the shaft 30 are located in a cylindrical face having a same diameter with the inner bearing surface of the bearing. Therefore, during rotation, only the outermost portions of the lobes 222A contact with the bearing. The lobes 222A are configured to have a substantially same abrasive resistance with the bearing. Alternatively, only the outermost portions of the lobes 222A are made of material with the substantially same abrasive resistance with the inner bearing surface of the bearing. Preferably, ceramic material is used for the bearing and the contact portion of the shaft, or only the inner bearing surface of the bearing and the outermost portions of the lobes 222A.

It is understood that the invention may be embodied in other forms without departing from the spirit thereof. The above-described examples and embodiments are to be considered in all respects as illustrative and not restrictive, and the invention is not to be limited to the details given above.

1. A bearing assembly comprising:
a tube axially defining an inner hole;
a pair of radial bearings fixed in the inner hole and each having an inner bearing surface concentric with the inner hole; and
a shaft pivotably received in the inner hole, and comprising a pair of contact portions circumferentially formed at an outer periphery thereof confronting with corresponding inner bearing surfaces, each of the contact portions comprising an outer bearing surface being configured to have a substantially same abrasive resistance with the inner bearing surface to reduce wear thereon.

2. The bearing assembly as described in claim 1, wherein the outer bearing surfaces and the inner bearing surfaces are made of same material.

3. The bearing assembly as described in claim 2, wherein the outer bearing surfaces and the inner bearing surfaces are made of ceramic.

4. The bearing assembly as described in claim 1, wherein the outer bearing surfaces and the inner bearing surfaces are made of different materials with same abrasive resistance.

5. The bearing assembly as described in claim 1, wherein each of the contact portions is in a form of ring.

6. The bearing assembly as described in claim 1, wherein each of the contact portions has a configuration of multi-lobes such that outermost portions of the lobes constitute the contact surface thereof.

7. The bearing assembly as described in claim 1, wherein each of the contact portions is integrally formed with the shaft.

8. A bearing assembly comprising:
a tube defining an axial hole;
a bearing installed in the hole and having an inner bearing surface;
a shaft pivotably received in the hole and extending through the bearing; and
a contact member radially projecting from the shaft to the inner bearing surface of the bearing and axially extending through the bearing, the contact member having an outer bearing surface with a substantially same abrasive resistance with the inner bearing surface of the bearing for reducing wear thereon.

9. The bearing assembly as described in claim 8, wherein the inner bearing surface and the outer bearing surface are made of same material.

10. The bearing assembly as described in claim 9, wherein the inner bearing surface and the outer bearing surface are made of ceramic.

11. The bearing assembly as described in claim 10, wherein the bearing is a sleeve bearing.

12. The bearing assembly as described in claim 11, wherein the contact member has a cylindrical configuration.

13. The bearing assembly as described in claim 11, wherein the contact member comprises a plurality of lobes having outermost portions forming the outer bearing surface.

14. The bearing assembly as described in claim 8, wherein the outer bearing surface and the inner bearing surface are made of different materials with same abrasive resistance.
